(19) United States
(12) Patent Application Publication
(10) Pub. No.: US 2008/0315856 A1
(43) Pub. Date: Dec. 25, 2008

(54) BANDGAP REFERENCE VOLTAGE GENERATOR CIRCUIT

(75) Inventors: Yukiko Takiba, Kanagawa-ken (JP); Akihiro Tanaka, Tokyo (JP); Hiroshi Suzunaga, Kanagawa-ken (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/142,996

(22) Filed: Jun. 20, 2008

(30) Foreign Application Priority Data
Jun. 21, 2007 (JP) 2007-163523

(51) Int. Cl. G05F 3/16

(52) U.S. Cl. 323/313; 323/315

(57) ABSTRACT

A bandgap reference voltage generator circuit includes a substrate made of a semiconductor of a first conductivity type, a first transistor formed on the substrate, a second transistor formed on the substrate and having a base commonly connected to the base of the first transistor, a light absorption region formed on the substrate, having a second conductivity type, and connected in parallel between the collector layer of the second transistor and the substrate and a reference voltage output terminal commonly connected to the bases of the first and second transistor. The area of the collector layer of the first transistor is larger than the area of the collector layer of the second transistor.

### CROSS-REFERENCE TO RELATED APPLICATIONS

This application is based upon and claims the benefit of priority from the prior Japanese Patent Application No. 2007-163523, filed on Jun. 21, 2007; the entire contents of which are incorporated herein by reference.

### BACKGROUND OF THE INVENTION

1. Field of the Invention

This invention relates to a bandgap reference voltage generator circuit.

2. Background Art

In a semiconductor integrated circuit, a bandgap reference voltage generator circuit can be used to obtain a reference voltage with small temperature variation. Using the fact that the base-emitter forward voltage of a silicon transistor has a temperature dependence of approximately −2 mV/° C., the bandgap reference voltage generator circuit cancels out this temperature dependence by circuitry.

Recently, more and more semiconductor photosensor devices such as photodetectors have been used in mobile devices. Also in such cases, a bandgap reference voltage generator circuit is often used.

Japanese Patent No. 3612089 discloses a technique related to a bandgap reference power supply. In this technique, in a monolithic transistor where one or more pairs of transistors having common bases and collectors and requiring a prescribed emitter area ratio are juxtaposed, the precision of the emitter area ratio is improved.

However, in semiconductor photosensor devices, unfortunately, light impinging on the integrated circuit chip produces a parasitic current, which varies the reference voltage.

### SUMMARY OF THE INVENTION

According to an aspect of the invention, there is provided a bandgap reference voltage generator circuit including: a substrate made of a semiconductor of a first conductivity type;

a first transistor formed on the substrate; a second transistor formed on the substrate and having a base commonly connected to the base of the first transistor; a light absorption region formed on the substrate, having a second conductivity type, and connected in parallel between the collector layer of the second transistor and the substrate; and a reference voltage output terminal commonly connected to the bases of the first and second transistor, the area of the collector layer of the first transistor being larger than the area of the collector layer of the second transistor.

According to another aspect of the invention, there is provided a bandgap reference voltage generator circuit including: a substrate made of a semiconductor of a first conductivity type; a first transistor formed on the substrate; a second transistor formed on the substrate and having a collector layer with a smaller area than the collector layer of the first transistor; a light absorption region formed on the substrate, having a second conductivity type, and connected in parallel between the collector layer of the second transistor and the substrate; a reference voltage output terminal commonly connected to the bases of the first and second transistor; a first resistor having one terminal connected to the emitter of the first transistor; and a second resistor placed between a node connecting the other terminal of the first resistor to the emitter of the second transistor and the substrate, temperature dependence of output voltage from the reference voltage output terminal being possible to be reduced by varying a ratio of an area of the emitter of the first transistor to an area of the emitter of the second transistor, a value of the first resistor and a value of the second resistor, respectively.

According to another aspect of the invention, there is provided a bandgap reference voltage generator circuit including: a substrate made of a semiconductor of a first conductivity type; a first transistor formed on the substrate; a second transistor formed on the substrate; a light absorption region formed on the substrate, having a second conductivity type, and connected in parallel between the collector layer of the second transistor and the substrate; and a reference voltage output terminal commonly connected to the bases of the first and second transistor, a parasitic photocurrent produced between a collector layer of the first transistor and the substrate being possible to be generally equal to a parasitic photocurrent produced between the collector layer of the second transistor and the substrate by generally equalizing an area of the collector layer of the first transistor to a sum of an area of the collector layer of the second transistor and an area of the light absorption region.

### BRIEF DESCRIPTION OF THE DRAWINGS

FIG. 1 is a circuit diagram of a bandgap reference voltage generator circuit according to a first embodiment of the invention;

FIGS. 2A and 2B show pattern layouts of the first embodiment;

FIGS. 3A and 3B are schematic cross-sectional views of part of a chip;

FIG. 4 is a graph showing the illuminance dependence of reference voltage Vref;

FIG. 5 is a pattern layout according to a second embodiment;

FIG. 6 is a pattern layout according to a third embodiment;

FIG. 7 is a pattern layout according to a fourth embodiment; and

FIG. 8 is a pattern layout according to a fifth embodiment.

### DETAILED DESCRIPTION OF T HE INVENTION

Embodiments of the invention will now be described with reference to the drawings.

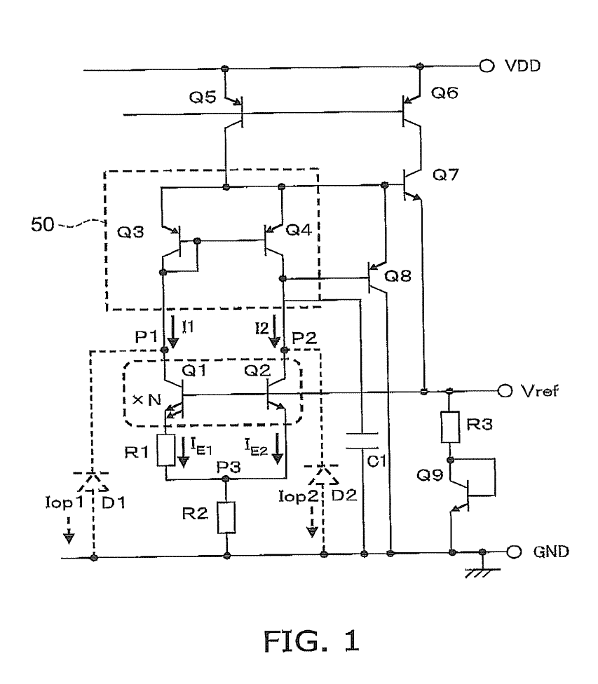

FIG. 1 is a circuit diagram of a bandgap reference voltage generator circuit according to a first embodiment of the Invention. A current I1 flows into a bipolar transistor Q1, and a resistor R1 is connected to its emitter. A current I2 flows into a bipolar transistor Q2, its emitter is connected at a node P3 to the resistor R1 connected to Q1, and the node P3 is grounded through a resistor R2. A reference voltage Vref is outputted from a reference voltage output terminal commonly connected to the base of Q1 and the base of Q2. The emitter area A1 of Q1 is set to N (=A1/A2) times the emitter area A2 of Q2.

In this figure, the current I1 flowing into Q1 and the current I2 flowing into Q2 are controlled by a current mirror circuit 50 composed of PNP transistors Q3 and Q4. In the first embodiment, I1 and I2 are generally equal. However, the invention is not limited thereto.

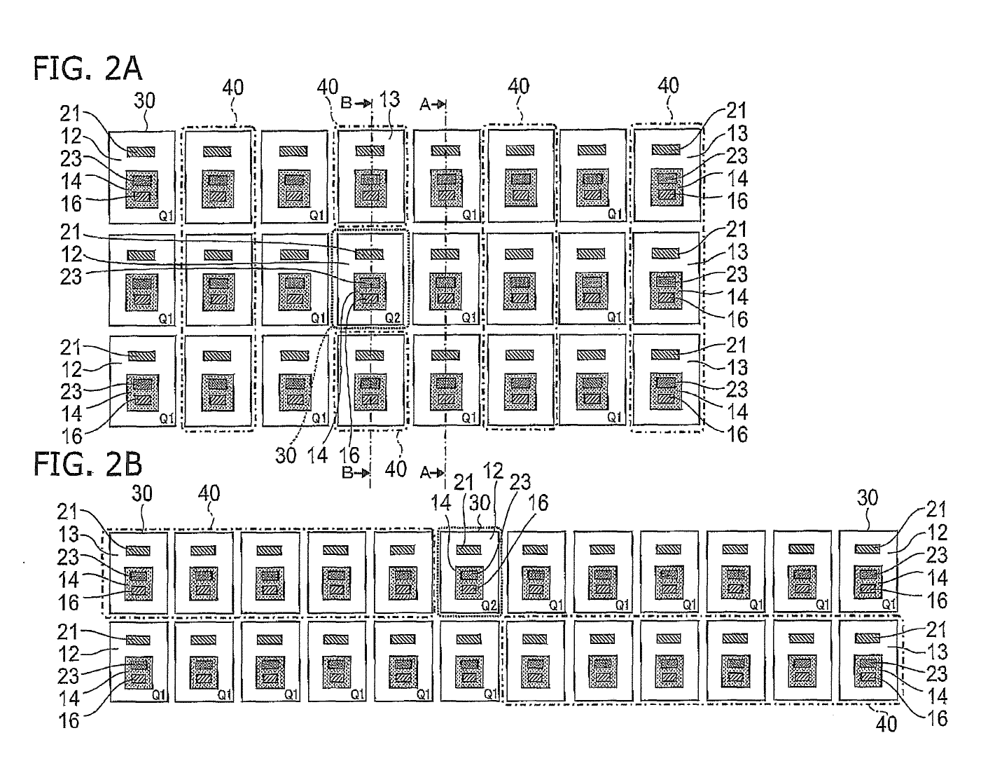

FIG. 2A shows a pattern layout of the first embodiment. This figure shows a surface pattern before interconnection of electrode metals. Unit transistors, each composed of an emitter layer 16, a base layer 14, and a collector layer 12 (or a light absorption region 13), have an identical shape and identical size for Q1, Q2, and a parasitic photocurrent canceling region 40. The ratio of the number of unit transistors serves as the emitter area ratio N. These unit transistors are arranged in a 3×8 (three rows, eight columns) matrix. A single Q2 is located at the second row, fourth column, and a total of twelve Q1's are located in the first, third, fifth, and eighth column. A total of eleven parasitic photocurrent canceling regions 40 are located In each row of the second, sixth, and eighth column and in the first and third row of the fourth column.

The collector layers 12, the base layers 14, and the emitter layers 16 of the twelve Q1's are commonly connected by interconnects, respectively (not shown), and the Q1's operate as a transistor having an emitter area twelve (N) times as large as that of Q2. The parasitic photocurrent canceling region 40 includes an emitter layer 16 and a base layer 14 having generally the same structure, but does not operate as a transistor because they are not connected to the power supply. The layer having generally the same structure as the collector layer 12 serves as a light absorption region 13.

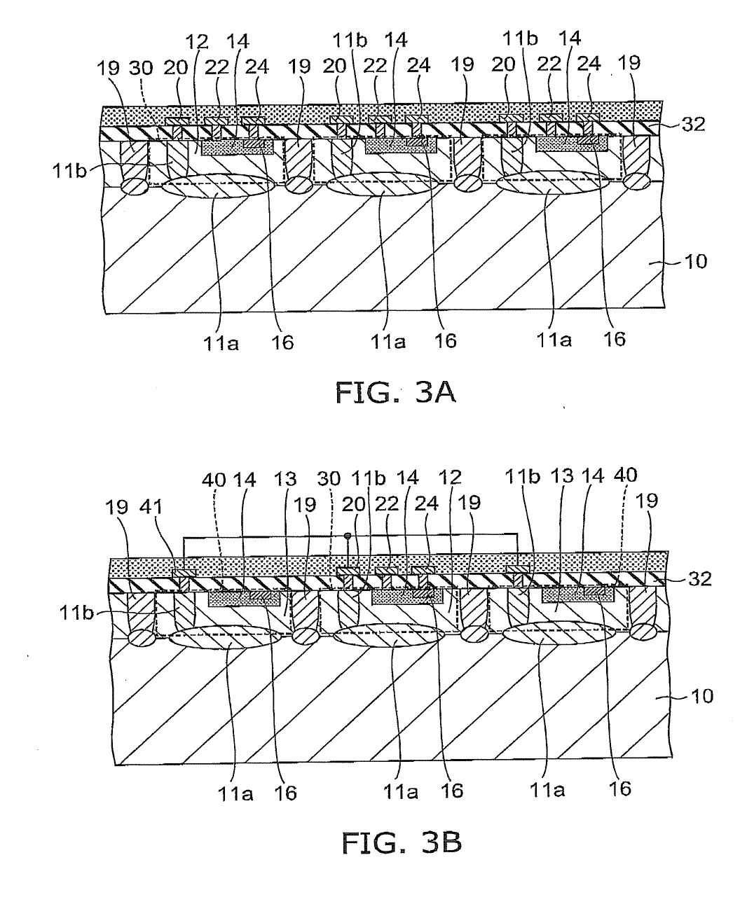

FIG. 3 is a schematic cross-sectional view of the first embodiment. FIG. 3A shows the cross section of three Q1's taken along line A-A in FIG. 2A, and FIG. 3B shows the cross section taken along line B-B. In FIG. 3A, an N⁺-layer 11a is formed on a P-type substrate 10, and an N-type epitaxial layer is formed on the N⁺-layer 11a. In a collector layer 12 made of the N-type epitaxial layer, a P-type base layer 14 is selectively formed, and an emitter layer 16 is further selectively formed in the base layer 14. Thus, each of the twelve Q1's are made of the same unit transistor. An insulating film 32 is provided thereabove, and openings serving as a collector contact 21 and a base contact 23 are formed in the insulating film 32. The area of the collector layer 12 refers to the inside portion of the N-type epitaxial layer separated by P⁺-layers 19, and the portion is referred to as a collector island 30 (dashed line), including the N⁺-layer 11b, the base layer 14, and the emitter layer 16 buried therein.

FIG. 3B shows a cross section where one Q2 is interposed between two parasitic photocurrent canceling regions 40. The light absorption regions 13 of the eleven parasitic photocurrent canceling regions 40 are all connected to the collector electrode 20 of Q2. The area of the light absorption region 13 refers to the inside portion of the N-type epitaxial layer separated by P⁺-layers 19, and the portion serves as a parasitic photocurrent canceling region 40 (dashed line), including the N⁺-layer 11b buried therein. The PN junction formed by the light absorption region 13 and the substrate 10 is reverse biased to act as a photodiode.

Thus, by light irradiation, a parasitic current flows from the light absorption region 13 toward the substrate 10. Q2 and the parasitic photocurrent canceling region 40 are made of unit transistors having the same composition, film thickness, and size. The collector electrode 20 of Q2 is connected to the electrode 41 connected to the light absorption region 13 of the parasitic photocurrent canceling region 40 (FIG. 3B), and the sum of the parasitic current of Q2 and the parasitic current of the parasitic photocurrent canceling region 40 is Iop2. In a comparative example with no parasitic photocurrent canceling region 40, the collector electrodes 20, base electrodes 22, and emitter electrodes 24 of twelve Q1's are commonly connected by interconnects, respectively, and the emitter area and the collector area are twelve times as large as those of Q2.

The substrate 10 is typically grounded. As shown by dashed lines in FIG. 1, if a parasitic current Iop1 flows between the point P1 and the ground (GND) by light irradiation and a parasitic current Iop2 flows between the point P2 and the ground, then the emitter current I_{E1} of Q1 becomes lower than I1, and the emitter current I_{E2} of Q2 becomes lower than I2. In the comparative example, the balance between the current flowing into Q1 and the current flowing into Q2 is broken, varying the value of Vref. In this case, it can be considered that the radiation-induced parasitic current is generally proportional to the area of the N-type epitaxial layer.

In this embodiment including parasitic photocurrent canceling regions 40 as shown in FIG. 3A, the sum Iop2 of the parasitic current flowing through the collector electrode 20 of Q2, having a smaller area than the collector layer 12 of Q1, and the parasitic current flowing through the light absorption region 13 connected at P2 to the collector electrode 20 is approximated to the parasitic current Iop1 of Q1 to reduce the difference in the influence of parasitic current. This improves the balance of emitter current and reduces the variation in the value of Vref. In the case where I_{E1}=I_{E2}, the influence of parasitic current can be further reduced by generally equalizing the area of the N-type epitaxial layer as shown in FIG. 2A. On the other hand, even in the case where I_{E1} is not equal to I_{E2}, the Influence of parasitic current can be further reduced if the ratio of the area of the collector layer 12 of Q1 to the sum of the area of the collector layer 12 of Q2 and the area of the light absorption region 13 is made generally equal to the ratio of I_{E1} to I_{E2}.

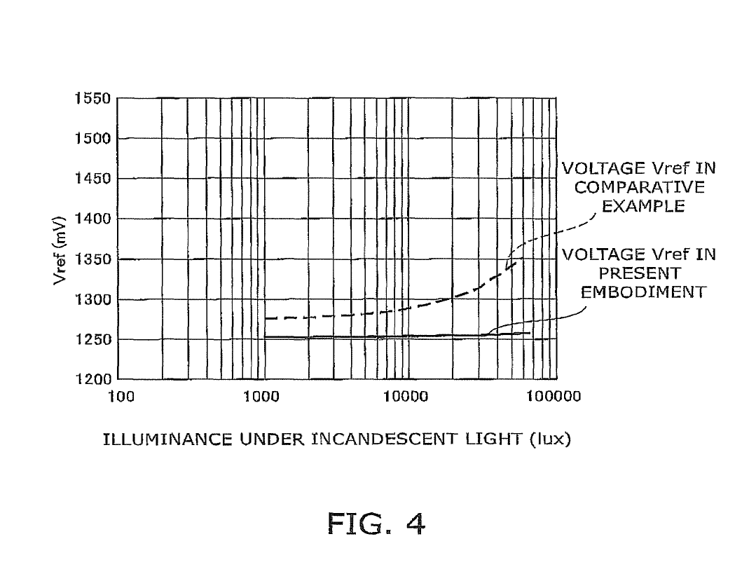

FIG. 4 is a graph showing the illuminance dependence of reference voltage Vref. The vertical axis represents Vref (mV), and the horizontal axis represents illuminance under incandescent light (in lux, lx). The solid line indicates this embodiment, and the dashed line indicates the comparative example. In the comparative example, Vref has a small variation around an illuminance of 1000 lx, but Vref gradually increases with the increase of illuminance. In particular, the rate of change of Vref becomes higher at an illuminance of 10000 lx or more. In contrast, in this embodiment, Vref can be restricted to a small variation of 1252 to 1258 mV in the range of 1000 to 65000 lx.

It is noted that, as an alternative method for reducing the influence of radiation-induced parasitic current, Q1 and Q2 can be shaded with a metal interconnect layer. However, because incandescent light, which contains a high proportion of infrared components, reaches deep into silicon, light incident on the scribe section of the chip may cause a parasitic current. Thus, this method is inadequate. For example, a photosemiconductor apparatus installed on a mobile device needs a detection illuminance of up to approximately 100,000 lx. However, under shading by metal interconnection, Vref increases in proportion to illuminance of Incandescent light at 20,000 to 30,000 lx or more. Thus, Vref, which is approximately 1270 mV in the dark, increases to 1350 mV at 50,000 to 60,000 lx, which is not adequate for a reference voltage.

Here, the operation of reducing temperature variation in the reference voltage is described using the circuit diagram of FIG. 1. The difference ΔVbe of base-emitter forward voltage between Q2 and Q1, denoted by VR1, is given by formula (1):

$$\begin{matrix}VR 1 = Δ Vbe \\ = Vbe ( Q 2 ) - Vbe ( Q 1 ) \\ = Vt \times ln [ \frac{I 2}{A 2 \times Is} \times \frac{A 1 \times Is}{I 1} ] \\ = Vt \times ln [ \frac{I 2}{A 2} \times \frac{A 1}{I 1} ] \\ = Vt \times ln [ N \times \frac{I 2}{I 1} ]\end{matrix} \\ where N = \frac{A 1}{A 2} . \qquad ( 1 )$$

As expressed by formula (1), the difference ΔVbe of base-emitter forward voltage between Q1 and Q2 is derived from the current density difference, which allows generation of reference voltage. That is, the requirement is N×I2/I1>1, which means that the current density is higher in Q2 than in Q1.

In this case, the reference voltage Vref is given by formula (2):

Vref=Vbe(Q2)+R2×(I1+I2) (2)

Even if I1 is not equal to I2, the temperature dependence of Vref can be controlled using formulas (1) and (2), Here, if I1=I2 is assumed to neglect the influence of base current in Q1 and Q2, then I1=VR1/R1=I2. More preferably, by using formula (1), Vref can be simplified as formula (3), which facilitates controlling the temperature dependence:

$$\begin{matrix}Vref = Vbe ( Q 2 ) + R 2 \times 2 \times VR 1 / R 1 \\ = Vbe ( Q 2 ) + 2 \times \frac{R 2}{R 1} \times Vt \times ln N\end{matrix} \qquad ( 3 )$$

Vt, given by formula (4), is proportional to the absolute temperature:

$$Vt = \frac{kT}{q} \qquad ( 4 )$$

where k is the Boltzmann constant, q is the electrical charge on the electron, and T is the absolute temperature.

In formula (3), the first term, Vbe(Q2), has a temperature dependence of approximately −2 mV/° C. Hence, if the second term is positive, the temperature dependence of Vref can be decreased. That is, the temperature dependence of Vref can be controlled by adjusting R1, R2, and N. For example, if the second term can be set to approximately 2 mV/° C., the temperature dependence of Vref can be approximated to zero. In this case, the negative first term cannot be canceled out unless In N Is positive. That is, N>1 is preferable.

In FIG. 4, Vref increases with the increase of illuminance under incandescent light. It is difficult to express the influence of parasitic currents Iop1 and Iop2 by formula (2) or (3). Occurrence of parasitic current means that, in FIG. 1, the diode D1 between the light absorption region 13 and the substrate 10 is connected between P1 and the ground and the diode D2 is connected between P2 and the ground. This makes Vref more complex than formulas (2) and (3). However, FIG. 4 indicates that the balance of parasitic currents between Q1 and Q2 allows the variation of Vref to be held down.

N does not need to be an integer. However, if N is an integer, the pattern layout is facilitated, and the temperature dependence can be controlled by adjusting R1 and R2. More specifically, in the case of setting the emitter area ratio N and the case of varying the area of the light absorption region 13 to equalize the parasitic currents, adjustment based on the ratio of the number of unit transistors allows the size effect to be common and facilitates improving the precision.

FIG. 2B shows a variation of the first embodiment, including 12×2=24 collector islands 30 (dashed line), each having a collector layer 12 made of an N-type epitaxial layer, a base layer 14, and an emitter layer 16. Q2 is located in the first row and the sixth column from the left. Q1's are consecutively located in the first row and the first to sixth column from the right, and also consecutively located in the second row and the first to sixth column from the left. Parasitic photocurrent canceling regions 40 (dashed line), each of which includes a light absorption region 13 made of the same N-type epitaxial layer as the collector layer 12 and has the same unit transistor as the unit transistor of the collector island 30, are located in the first row and the first to fifth column from the left, and in the second row and the first to sixth column from the right. A total of eleven parasitic photocurrent canceling regions 40 are located, smaller by one than the number of Q1's. The pattern layout of FIG. 2B is horizontally longer than the pattern layout of FIG. 2A. Either optimal one of these layouts can be selected in the pattern design of a semiconductor chip. The layout of FIG. 2A, having an aspect ratio close to 1 and including Q1's and parasitic photocurrent canceling regions 40 generally alternately, is superior in pairing and facilitates achieving more uniform characteristics.

The embodiment of FIG. 2 and the variation associated therewith are based on the same basic pattern of the emitter layer 16, the base layer 14, and the collector island 30 (or parasitic photocurrent canceling region 40). The emitter area ratio N and the area of the parasitic photocurrent canceling region 40 are adjusted by varying the number of unit transistors. This facilitates achieving desired characteristics based on high pattern precision of photolithography. Furthermore, the pattern can be located distributively, and paring can be easily improved.

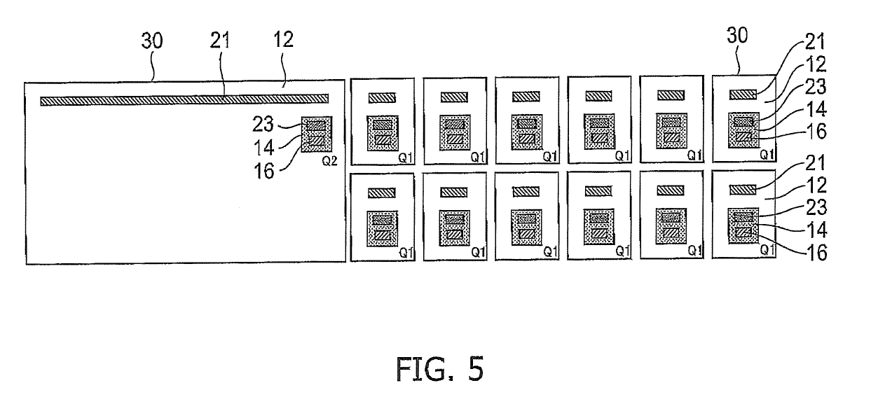

FIG. 5 is a pattern layout according to a second embodiment. Twelve-part split Q1's each including a collector island 30, are formed on the right side of FIG. 5, and one collector island 30 having an area equal to the total area of the collector islands 30 of the twelve Q1's is formed on the left side. One Q2, having the same base area as one Q1, is located at a position adjacent to Q1 in the left collector island 30. The rest of the N-type epitaxial layer serves as a light absorption region 13 and is connected to the collector layer 12 of Q2 through a collector contact 21. The parasitic current Iop1 occurring in Q1's composed of twelve unit transistors and the parasitic current Iop2 occurring in Q2 and the light absorption region 13 flow in a balanced manner, and the influence on Vref is held down. In this embodiment, the structure of the pattern layout can be simplified.

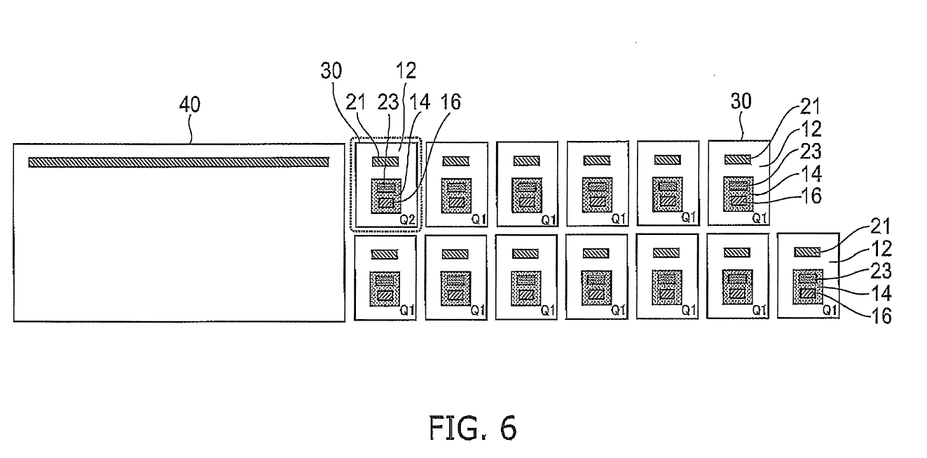

FIG. 6 is a pattern layout according to a third embodiment. One Q2 is located around the center of FIG. 6. Five Q1's are located on the right side in the same row, and seven Q1's are located in the second row. On the left side, a light absorption region 13 serving as a parasitic photocurrent canceling region 40 is integrally located and connected in parallel to the collector layer 30 of Q2. The area of the light absorption region 13 of the parasitic photocurrent canceling region 40 is equal to the difference in the area of collector islands between Q1 and Q2. Also in this case, the structure can be simplified.

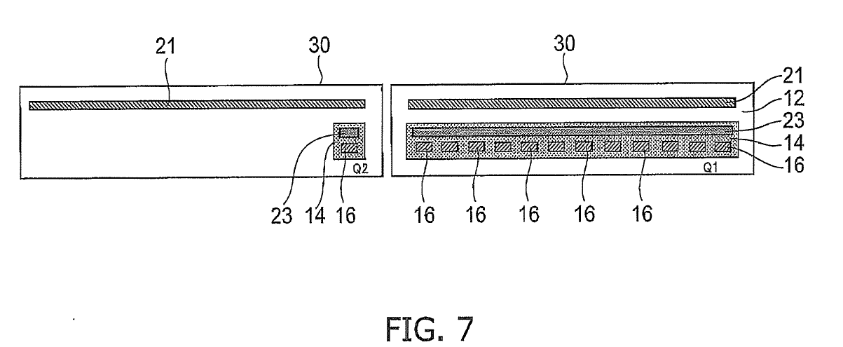

FIG. 7 is a pattern layout according to a fourth embodiment. In the first to third embodiment, Q1's are made of divided collector islands 30. However, the base layer 14 and the collector layer 12 can be shared. In this figure, in Q1, the collector layer 12, the collector contact 21, and the base contact 23 are shared. This can simplify the pattern layout. On the other hand, even with the same emitter area, the emitter layer 16 is likely to vary in characteristics with the emitter width and the distance to the base contact 23. Hence, it is preferable to use twelve unit transistors for the emitter layer 16 as shown in FIG. 7. The N-type epitaxial layer around Q2 serves as a collector layer 12, and the N-type epitaxial layer in the collector island 30 serves as a light absorption region 13.

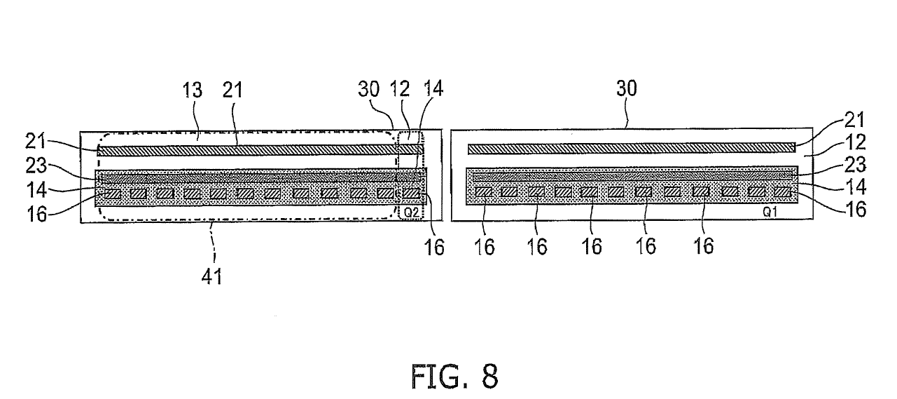

FIG. 8 is a pattern layout according to a fifth embodiment. Twelve emitter layers 16 having a common collector layer 12, a common collector contact 21, and a common base contact 23 are located on the right: side. On the left side, twelve emitter layers 16, a common collector contact 21, and a common base contact 23 are located in a collector island 30. Q2 includes one of the emitter layers 16 in the collector island 30, and the region 41 including the remaining eleven emitter layers serves as a parasitic photocurrent canceling region. The number of connections to the emitter layers 16 can be selected in accordance with the emitter area ratio N to form Q2. In this case, the emitter area ratio N can be easily adjusted by changing the electrode pattern to vary the number of connections to the emitter layers 16.

According to the present embodiments, in a bandgap reference voltage generator circuit including two transistors, the variation of reference voltage upon light irradiation can be reduced by a light absorption region located in parallel between the substrate and the collector layer of the transistor having the smaller area of the collector layer. For example, Vref can be restricted to a small variation of 1252 to 1258 mV in the Irradiation range of 1000 to 65000 lx. Thus, a stable reference voltage against temperature variation and light irradiation can be supplied to mobile devices.

The embodiments of the invention have been described with reference to the drawings. However, the invention is not limited to these embodiments. For example, the shape, size, material, and positional relationship of the transistor, light absorption region, collector Island, and resistor constituting the bandgap reference voltage generator circuit can be modified by those skilled in the art without departing from the spirit of the invention, and any such modifications are also encompassed within the scope of the invention.

1. A bandgap reference voltage generator circuit comprising;
a substrate made of a semiconductor of a first conductivity type;
a first transistor formed on the substrate;
a second transistor formed on the substrate and having a base commonly connected to the base of the first transistor;
a light absorption region formed on the substrate, having a second conductivity type, and connected in parallel between the collector layer of the second transistor and the substrate; and
a reference voltage output terminal commonly connected to the bases of the first and second transistor,
the area of the collector layer of the first transistor being larger than the area of the collector layer of the second transistor.

2. The bandgap reference voltage generator circuit according to claim 1, further comprising: a current mirror circuit, the current mirror circuit being possible to control currents flowing into the first and second transistors, respectively.

3. A bandgap reference voltage generator circuit comprising,
a substrate made of a semiconductor of a first conductivity type;
a first transistor formed on the substrate;
a second transistor formed on the substrate and having a collector layer with a smaller area than the collector layer of the first transistor;
a light absorption region formed on the substrate, having a second conductivity type, and connected in parallel between the collector layer of the second transistor and the substrate;
a reference voltage output terminal commonly connected to the bases of the first and second transistor;
a first resistor having one terminal connected to the emitter of the first transistor; and
a second resistor placed between a node connecting the other terminal of the first resistor to the emitter of the second transistor and the substrate,
temperature dependence of output voltage from the reference voltage output terminal being possible to be reduced by varying a ratio of an area of the emitter of the first transistor to an area of the emitter of the second transistor, a value of the first resistor and a value of the second resistor, respectively.

4. The bandgap reference voltage generator circuit according to claim 1, wherein an emitter current of the first transistor is generally equal to an emitter current of the second transistor.

5. The bandgap reference voltage generator circuit according to claim 1, wherein an area of the emitter of the first transistor is larger than an area of the emitter of the second transistor.

6. The bandgap reference voltage generator circuit according to claim 5, wherein the area of the emitter of the first transistor is an integral multiple of the area of the emitter of the second transistor.

7. A bandgap reference voltage generator circuit comprising:
a substrate made of a semiconductor of a first conductivity type;
a first transistor formed on the substrate;
a second transistor formed on the substrate;
a light absorption region formed on the substrate, having a second conductivity type, and connected in parallel between the collector layer of the second transistor and the substrate; and
a reference voltage output terminal commonly connected to the bases of the first and second transistor,
a parasitic photocurrent produced between a collector layer of the first transistor and the substrate being possible to be generally equal to a parasitic photocurrent produced between the collector layer of the second transistor and the substrate by generally equalizing an area of the collector layer of the first transistor to a sum of an area of the collector layer of the second transistor and an area of the light absorption region.

8. The bandgap reference voltage generator circuit according to claim 7, further comprising: a current mirror circuit, the current mirror circuit being possible to control currents flowing into the first and second transistors, respectively.

9. The bandgap reference voltage generator circuit according to claim 7, the first and second transistors including unit transistors having generally an identical shape and identical size.

10. The bandgap reference voltage generator circuit according to claim 9, wherein the area of the collector layer of the first transistor is an integral multiple of the area of the collector layer of the second transistor.

11. The bandgap reference voltage generator circuit according to claim 10, wherein the collector layer of the first transistor is dispersedly located.

12. The bandgap reference voltage generator circuit according to claim 9, wherein the light absorption region includes unit regions which are dispersedly located, the unit regions being generally equal in a shape, size and composition to the collector layer of the unit transistor.

13. The bandgap reference voltage generator circuit according to claim 12, wherein the collector layer of the second transistor is adjacent to one of the collector layers of the first transistors dispersedly located and one of unit regions of the light absorption region dispersedly located, respectively.

14. The bandgap reference voltage generator circuit according to claim 12, wherein the first transistor dispersedly located and the unit region of the light absorption region dispersedly located are located around the second transistor.

15. The bandgap reference voltage generator circuit according to claim 12, wherein the collector layer of the first transistor dispersedly located and the unit region of the light absorption region dispersedly located are alternately located at least in one direction.

16. The bandgap reference voltage generator circuit according to claim 7, wherein a base layer, a base contact, the collector layer and a collector contact of the first transistor are shared.

17. The bandgap reference voltage generator circuit according to claim 7, wherein the light absorption region is consecutive and has common contacts.

18. The bandgap reference voltage generator circuit according to claim 17, wherein the light absorption region does not include base layer and emitter layer.

19. The bandgap reference voltage generator circuit according to claim 7, wherein the area of the collector layer of the first transistor sharing the collector layer is generally equal to the sum of the area of the collector layer of the second transistor and the area of the light absorption region consecutively provided each other.

20. The bandgap reference voltage generator circuit according to claim 1, wherein the light absorption region, the collector layer of the first transistor, and the collector layer of the second transistor have generally same composition and film thickness.
